(19) United States
(12) Patent Application Publication
(10) Pub. No.: US 2026/0135231 A1
(43) Pub. Date: May 14, 2026

(54) MODULAR BATTERY RACK SYSTEM

(71) Applicant: Caterpillar Inc., Peoria, IL (US)

(72) Inventors: Krishna Prasath Ramabadhran, Krishnagiri (IN); Prakash Prashanth Ravi, Bengalore (IN)

(73) Assignee: Caterpillar Inc., Peoria, IL (US)

(21) Appl. No.: 18/946,572

(22) Filed: Nov. 13, 2024

(51) Int. Cl. H01M 50/267; H01M 50/258; H01M 50/264

(52) U.S. Cl. CPC H01M 50/267; H01M 50/258; H01M 50/264

(57) ABSTRACT

A battery rack includes a floor member having a rail portion and a carriage portion movably coupled to the rail portion. The battery rack may further include a pair of vertical walls, each having a bracket, a channel, and a movable fastener movably coupled to the channel and mechanically coupled to the bracket. Wherein the movable fastener can be configured to be in a movable state where the movable fastener is slidably movable along a length of the channel and a fixed state where the movable fastener is not slidably movable along a length of the channel at a length of the channel. The battery rack may further include at least one cross-support having a variable length and is mechanically coupled to the pair of vertical walls.

### TECHNICAL FIELD

This disclosure relates generally to battery rack systems and more particularly to a modular battery rack system.

### BACKGROUND

Battery racks used in energy storage systems are generally designed to fit a unique size and configuration of each battery. The specificity of each rack to a particular battery type can impede system flexibility and scalability and can limit adaptability to changing energy storage needs over time. This lack of flexibility might result in challenges when upgrading or expanding the system, potentially requiring significant modifications or even the replacement of entire racks. Moreover, with each battery uniquely configured within its designated rack, routine tasks such as monitoring, replacement, or repairs become more intricate and time-consuming as accessibility to individual batteries may be hindered.

For example, U.S. Pat. No. 9,755,200 describes an equipment cabinet. The equipment cabinet may include a corrugation in the side panels. The side panels are affixed to a base by bolting or welding so as to be disposed opposite each other. Holes are provided in opposing surfaces the so that cross members may be secured in a position between the opposing side panels of the cabinet to form a support structure for equipment, such as batteries. The equipment cabinet may further include an equipment retaining bracket includes a retaining cross member, an L-shaped bracket and a bolt to join the retaining cross member and the L-shaped bracket so as to secure the battery in two dimensions. The equipment cabinet may further include retaining brackets at the front and the rear surfaces of the equipment and, in cooperation with the cross members, retain the equipment in the cabinet.

### SUMMARY OF THE INVENTION

A first aspect provided herein relates to a battery rack includes a rail member having a rail and a pair of carriages movably coupled to the rail. The battery rack further includes a pair of vertical walls, each having a bracket, a column, and a movable fastener movably coupled to the column and mechanically coupled to the bracket. The movable fastener can be configured to be in a movable state where the movable fastener is slidably movable along a length of the column and a fixed state where the movable fastener is not slidably movable along a length of the column. Each of the pair of vertical walls are respectively mechanically coupled to the pair of carriages. The battery rack may further include at least one cross-support having a variable length and is mechanically coupled to the pair of vertical walls.

A second aspect provided herein relates to a method of assembling a battery rack, the method including providing a pair of vertical walls movably coupled to a rail. The method further includes translating a first vertical wall of the pair of vertical walls along the rail such that the first vertical wall is positioned a distance away from the second vertical wall of the pair of vertical walls. The method further includes positioning a variable length cross-support between the pair of vertical walls. The method further includes mechanically coupling the variable length cross-support to the pair of vertical walls. The method further includes positioning a shelf about a height of a first vertical wall of the pair of vertical walls. The method further includes movably coupling the shelf to the first vertical wall of the pair of vertical walls.

A third aspect provided herein relates to a modular battery rack system, the system including a pair of vertical walls, each vertical wall having a carriage coupled to a bottom end of the vertical wall, a vertical adjustment column, and a shelf that is movably mechanically coupled to the vertical adjustment column. The shelf has a movable state where the shelf can be moved along a height of the vertical adjustment column and a fixed state where the shelf is fixed about a point along the height of the vertical adjustment column. The system further includes a rail is movably mechanically coupled to each respective carriage. The system further includes at least one cross-support having a variable length, the at least one cross-support being mechanically coupled to the pair of vertical walls.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 depicts an embodiment of a front-side perspective view of a modular battery rack system.

FIG. 2 depicts an embodiment of an exploded front-side perspective view of a modular battery rack system.

FIG. 3A depicts a front-side perspective view of an embodiment of a vertical wall.

FIG. 3B depicts a front-side perspective view of an embodiment of a height adjustment system.

FIG. 4A depicts a front side perspective view of a rail system.

FIG. 4B depicts a zoomed in perspective view of a carriage positioned on a rail.

FIG. 5A depicts a front side perspective view of a cross-support.

FIG. 5B depicts a front side exploded perspective view of a cross-support.

FIG. 6 is a flowchart of an example method of assembling a modular battery rack system.

### DETAILED DESCRIPTION

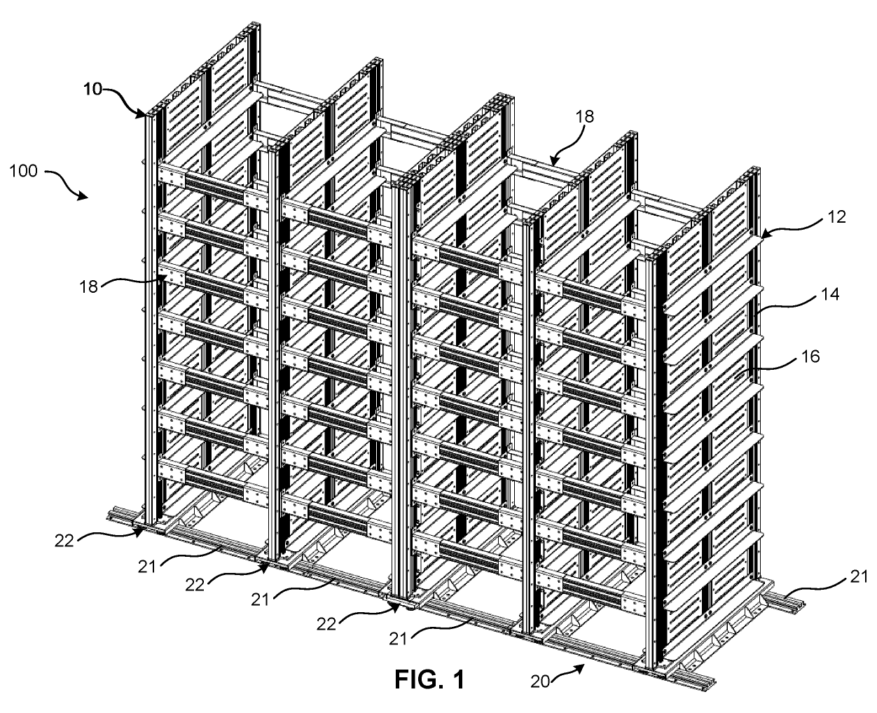

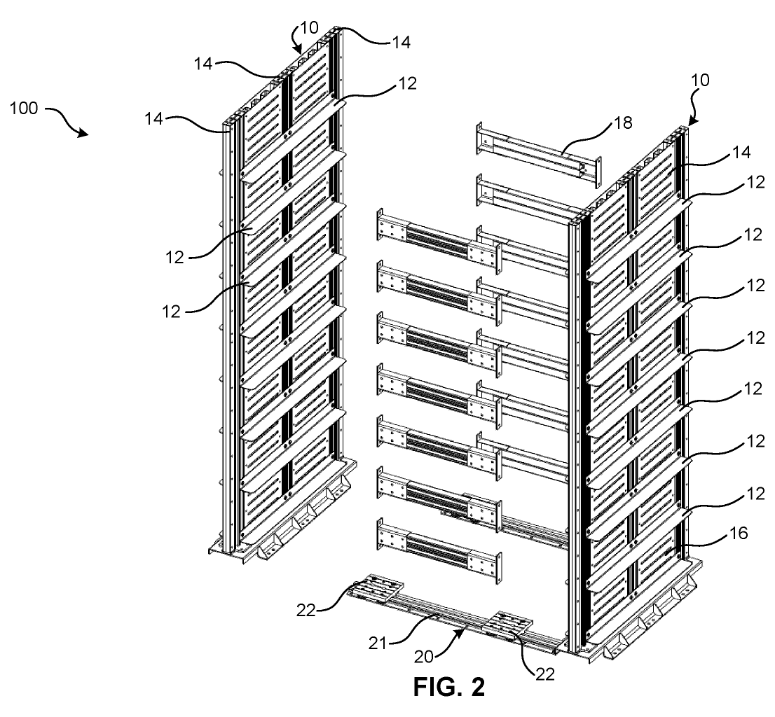

Referring to FIGS. 1 and 2, a modular battery rack system 100 includes a pair of opposed, vertical walls 10, a rail system 20, movable shelves or L-brackets 12 coupled to vertical columns 14. Each vertical wall 10 is coupled to a carriage 22 to facilitate moving the sidewall along the rail system 20. A plurality of cross-supports 18 couple each vertical wall 10 to an adjacent vertical wall 10. Each of the plurality of cross-supports 18 have an adjustable length to accommodate various spacing widths between the vertical walls 10 as set by the position of a sidewall’s carriage 22 position along the rail 21. The modular battery rack system 100 can vary or change the distance between adjacent vertical walls 10 by employing vertical walls 10 that are coupled to, attached to, secured to, or otherwise connected to a rail system 20 about the bottom end of the vertical wall 10. In this manner, each vertical wall 10 can be moved along the rail system 20 to alter the distance from one vertical wall 10 to the next vertical wall 10. Once the vertical wall 10 has reached its desired position, then the adjustable cross-support 18 is first adjusted to the proper length and installed to set the distance between the adjacent vertical walls 10. To accommodate for batteries of different heights, the modular battery rack system 100 include movable shelves or L-brackets 12 that can be adjusted or moved along the height of the vertical wall 10.

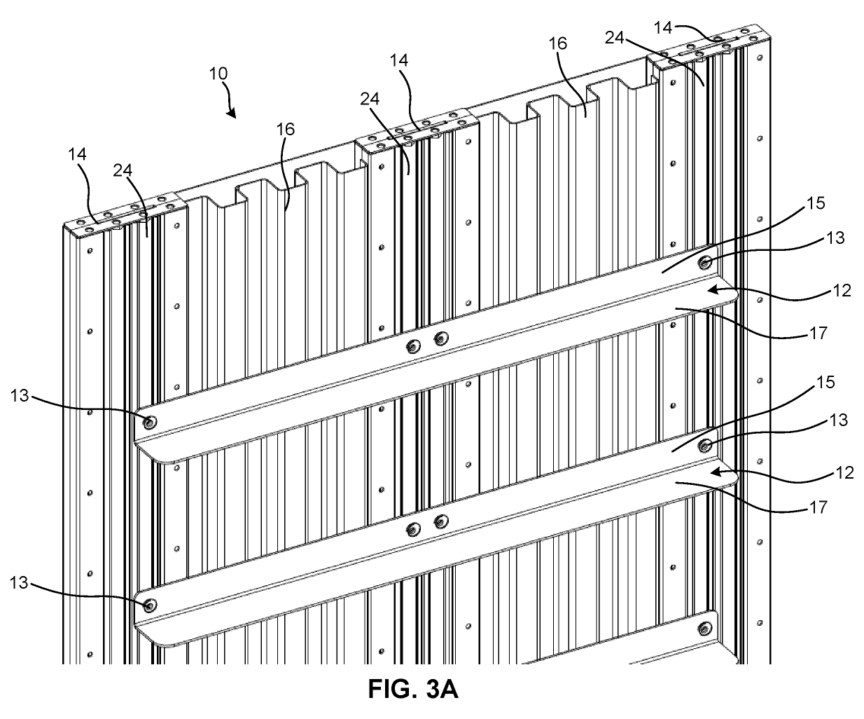

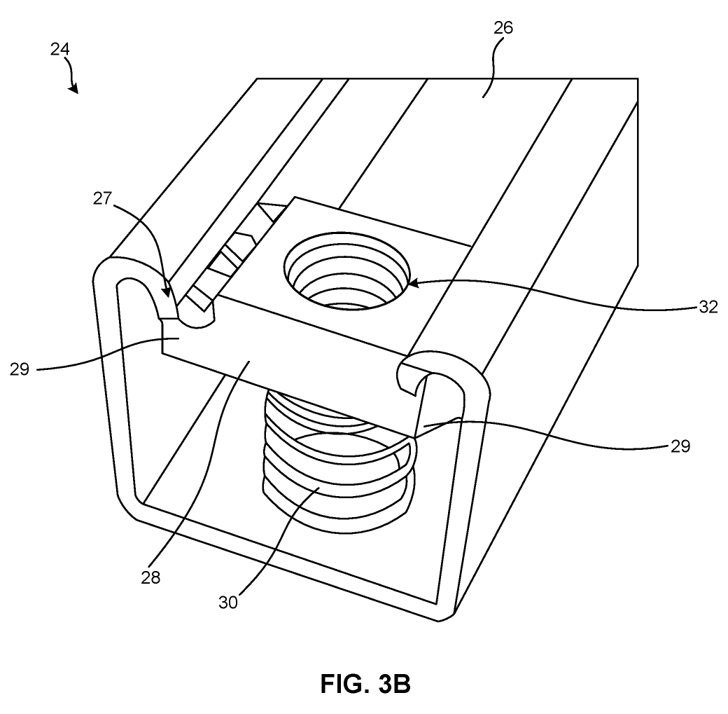

Reference is now made to FIG. 3A, which depicts a front-side perspective view of an embodiment of a vertical wall 10. A vertical wall 10 includes a vertical column 14, a wall member 16, a shelf 12, and a height adjustment system 24. A bottom end of the vertical column 14 is coupled to, secure two, or otherwise connected to a carriage 22 to facilitate or accommodate moving the vertical wall 10 along the length of the rail 21, as discussed in greater detail below. The vertical column 14 generally provides structural strength and rigidity to support the various batteries or components positioned on shelf 12. The wall member 16 extends between a pair of vertical columns 14 and is mechanically coupled, secured to, or otherwise connected to the pair of vertical columns 14 at each respective end of the wall member 16. The height adjustment system 24 is coupled to the vertical column 14 and allows for or accommodates for the shelves 12 to be movably coupled to the height adjustment system 24 in a manner that allows for the shelves 12 to be positioned about or along the height of the vertical column 14. It should be understood, that while the depicted embodiments depict each vertical column 14 as having its own height adjustment system 24, other configurations are also envisioned. For example, a vertical wall 10 may include multiple vertical columns 14 but only a single height adjustment system 24. In such embodiments, the position of the shelf 12 is first set with the height adjustment system 24 and then supporting fasteners, or any other suitable or desirable connecting components, are installed about the remaining connection points 13. As another example, a vertical wall 10 may include multiple height adjustment systems 24 for each vertical column 14.

In some implementations, a vertical wall 10 has three vertical columns 14 with two wall members 16 placed between and connecting adjacent vertical columns 14. It should be understood, that while the vertical wall 10 is depicted as having three vertical columns 14 and two wall members 16, other configurations are also envisioned. For example, the vertical wall 10 may include only two vertical columns 14 connected by a single wall member 16, the vertical wall 10 may be configured to include a single vertical column 14 with a pair of wall members 16 extending outwardly therefrom, the vertical wall 10 may be configured to include any suitable configuration of the number of vertical columns 14 and corresponding wall members 16. It should also be understood, that while wall member 16 is presently depicted as a sheet of corrugated metal, other configurations are also envisioned. For example, wall member 16 may have a flat profile, a ribbed profile, or any other suitable or desirable profile.

With continued reference to FIG. 3A, the shelves 12 or L-brackets are shown to movably mechanically couple to the vertical column 14 to allow for or accommodate varying heights of batteries. As the shelves 12 may be moved along the height of the vertical column 14, then the distance between the shelves 12 may be varied, increased, or decreased to accommodate for the appropriate or desired height of a battery. The shelf 12 includes an upright section 15 and a holding section 17 that is configured to support at least a portion of the weight of a battery. The upright section 15 also includes connection points 13 that are configured to receive a portion of a fastener therethrough to mechanically couple the shelf 12 to the vertical column 14.

Reference is now made to FIG. 3B, which depicts a front-side perspective view of a movable fastener 28 positioned within a channel 26. The height adjustment system 24 includes a channel 26, a movable fastener 28 with a threaded portion 32 and a spring 30 positioned under the threaded portion 32. The movable fastener 28 is configured to have a moving state, a positioning state, and a fixed state. In the moving state, the movable fastener 28 is able to be moved along and/or within the channel 26 by compressing the spring 30. When the spring 30 is compressed, the wing portions 29 of the movable fastener 28 shift away from the overlapping portions 27 of the channel 26, thereby allowing the movable fastener 28 to be moved along the channel 26. In the positioning state, the spring 30 is extended such that the wing portions 29 contact the overlapping portions 27 of the channel 26; the tension provided by spring 30 generally prevents the movable fastener 28 from unintentionally sliding or moving along the channel 26. Thus, the movable fastener 28 maybe positioned at the desired point along the channel 26 prior to being transitioned into the fixed state. In the fixed state, the threaded portion 32 receives a corresponding threaded member 31 (not shown) and when the threaded member 31 is tightened such that the winged portions 29 contact the overlapping portions 27 of the channel 26. It should be understood that while the threaded portion 32 is presently depicted as a female threaded portion, other configurations are also envisioned. For example, the threaded portion 32 may also be a male threaded portion, or any other suitable configuration that allows for the shelf 12 to be mechanically coupled to the vertical column 14.

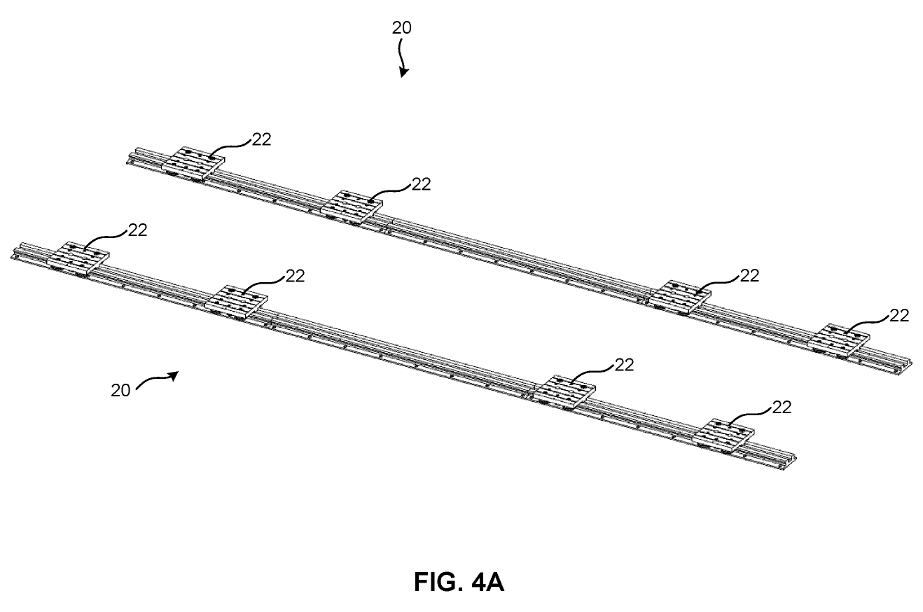

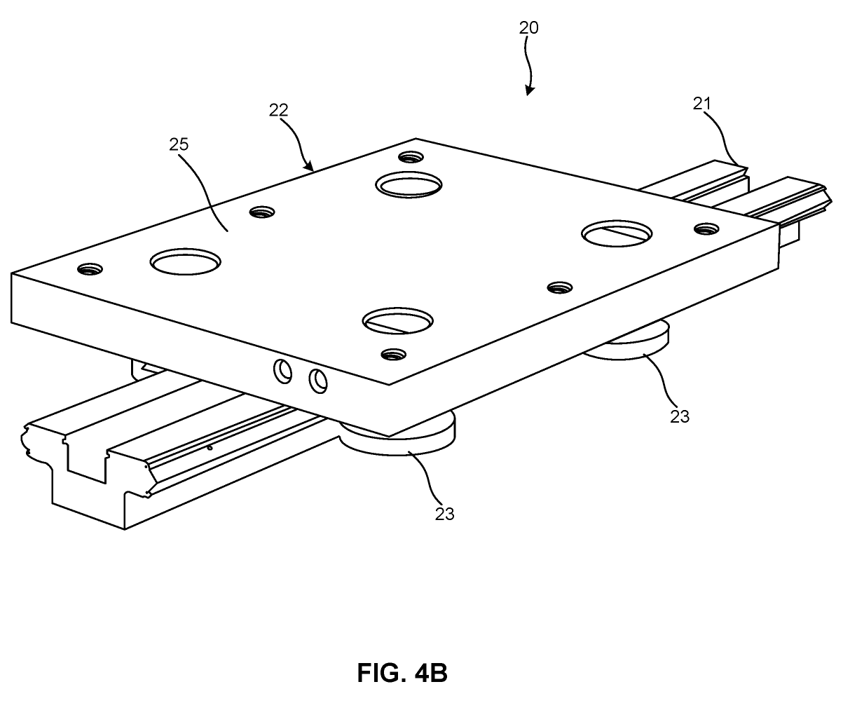

Reference is now made to FIGS. 4A and 4B, which respectively depict a front side perspective view of a rail system 20 and a zoomed in perspective view of a carriage 22 with rollers 23 positioned on a rail 21. The rail system 20 serves as the guide and support structure for the carriages 22 and vertical walls 10. The rail system 20 consists of rails 21 or tracks coupled to, secured to, embedded in, or otherwise connected to the floor of the space that contains the modular battery rack system 100, forming a precise pathway along which the vertical walls 10 can be maneuvered. The rail system 20 is configured to handle the weight of the modular battery rack system 100 and its various components. The carriage 22 has or includes rollers 23 that interface with rail 21 and a manner that allows for the carriage 22 to be movably coupled to the rail 21. When the carriage 22 is movably coupled to the rail 21, the carriage 22 can slide, traverse, or otherwise move along the full length of the rail 21. A bottom end of the vertical side wall 10 is coupled to, secured to, or otherwise connected to the top surface 25 of the carriage 22. In this manner, the vertical wall 10 may simultaneously slide, traverse, or otherwise move along the full length of the rail 21.

The carriage 22 is a component that facilitates the smooth movement of the vertical walls 10 along the rail system 20. The carriage 22 is a wheeled mechanism situated underneath each vertical wall 10, providing a stable platform that interacts with the rails 21. The carriages 22 are aligned with these rails 21, ensuring a synchronized movement when the vertical walls 10 are pushed or pulled. This collaborative operation between the carriage 22 and rail 21 allows for efficient and space-saving storage solutions, as users can easily reposition vertical walls 10 to access specific sections while maintaining an organized and compact storage layout.

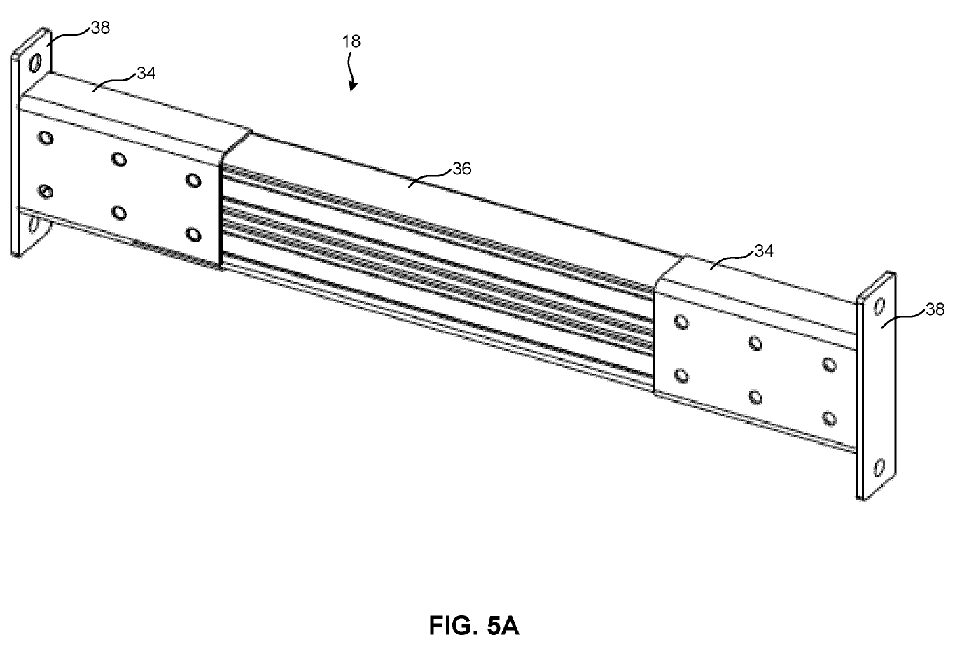

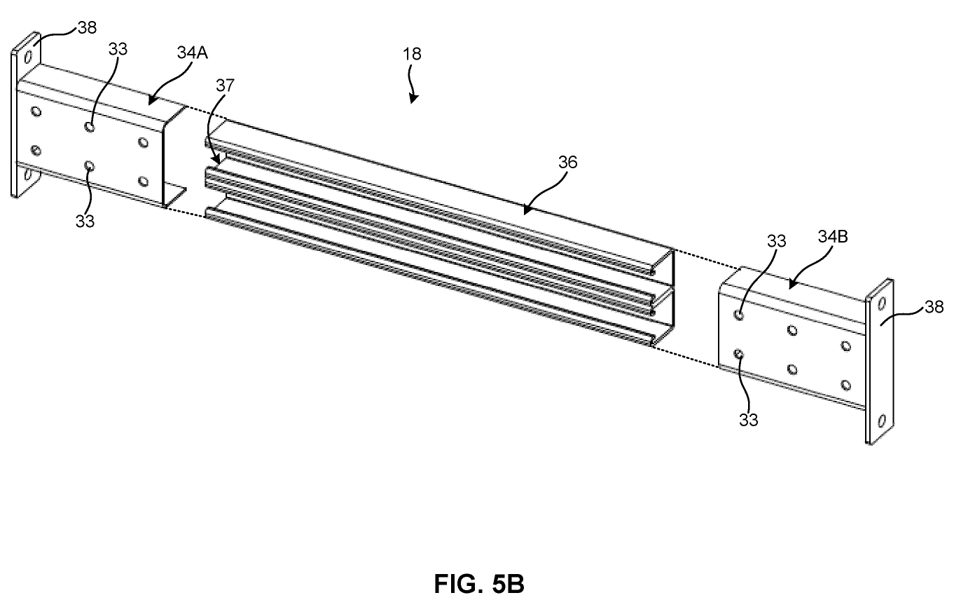

Reference is now made to FIGS. 5A and 5B, which respectively depict a front side perspective view of a cross-support 18 and an exploded view of a cross-support 18. A cross-support 18 includes a first coupling end 34A, a second coupling end 34B, and an extension member 36 position between the first coupling member 34A and the second coupling member 34B. the pair of coupling ends 34A, 34B, are movably coupled to the extension member 36 such that the distance between the first and second coupling ends 34A, 34B, can be varied or changed to accommodate for varying distances between vertical walls 10. Each coupling end 34 includes a coupling surface 38 that is configured to mechanically couple, secure, or otherwise connect the coupling end 34 to a vertical wall 10. The extension member 36 allows for the coupling ends 34 to reach or accommodate for larger distances between vertical walls 10. It should be understood, that while the cross-support 18 is presently depicted as including or having an extension member 36, other configurations are also envisioned. For example, cross-support 18 can include a pair of coupling ends 34A, 34B that are configured to couple directly to one another, without the need for an extension member 36.

The extension member 36 includes an extension channel 37, which can include or accept a movable fastener 28 as described in greater detail above. The movable fastener 28 can be positioned within the extension channel 36 and aligned with the fastener holes 33 to movably couple each respective coupling end 34A, 34B, to the extension member 36.

### INDUSTRIAL APPLICABILITY

In operation and use, a modular battery rack system 100 can support batteries of varying heights, widths, and depths without requiring large or invasive modifications to the rack. Take for example a situation where a piece of equipment is changing or swapping out the type of batteries that it was originally designed for with a battery that is smaller in size due to some efficiency gains. With current battery rack technology, the rack itself will need to be disassembled and fully reconfigured to specifically fit or accommodate the dimensions of the new batteries. With a modular battery rack system 100, the vertical walls 10 can be moved closer to or farther apart from one another to accommodate for the differing width and/or depth of the new battery type as compared to the old battery type. The shelves 12 that the batteries rest on can also be moved higher up or farther down the vertical column 14 to accommodate for the height of the new batteries as compared to the old batteries. The adjustability of the distance between adjacent vertical walls 10 and the distance between adjacent shelves 12 allow for the modular battery rack system 100 to accommodate batteries of varying heights, widths, and depths.

To alter or change the distance between one vertical wall 10 and an adjacent vertical wall 10, one or both of the vertical walls 10 are caused to move along the rail system 20 via the sliding motion of the carriage 22 along rail 21. Once the desired distance between the adjacent vertical walls 10 has been achieved, the cross-supports 18 are accordingly adjusted such that each respective coupling end 34 of the cross-support 18 contacts or is otherwise coupled to the respective vertical wall 10. In implementations that utilize a cross-support 18 with an extension member 36, each respective coupling end 34 may remain coupled to its respective vertical wall 10 during the period when the distance between the respective vertical walls 10 is being adjusted by loosening the movable fastener 28 prior to moving one or both of the respective vertical walls 10 closer or farther apart to one another. Once the desired distance has been achieved, the movable fastener 28 may then be tightened or torqued to a suitable or desired tightness to set the distance between each respective coupling end 34 and their respective vertical walls 10. This alteration of distance between adjacent Vertical side walls 10 allows for the modular battery rack system 100 to accept, receive, or otherwise accommodate batteries of varying depths and/or widths without requiring full disassembly or other major modifications of the modular battery rack system 100.

To alter or change the distance between one shelf 12 and an adjacent shelf 12, the movable fasteners 28 associated with one or both of the respective shelves 12 are loosened to allow the respective shelf 12 to move vertically along the height adjustment system 24. Once the desired distance between the adjacent shelves 12 has been achieved, the movable fasteners 28 that had previously been loosened may then be tightened or torqued to a suitable or desired tightness to set the distance between each respective shelf 12. This alteration of distance between adjacent shelves 12 allows for the modular battery rack system 100 to accept, receive, or otherwise accommodate batteries of varying heights without requiring full disassembly or other major modifications of the modular battery rack system 100.

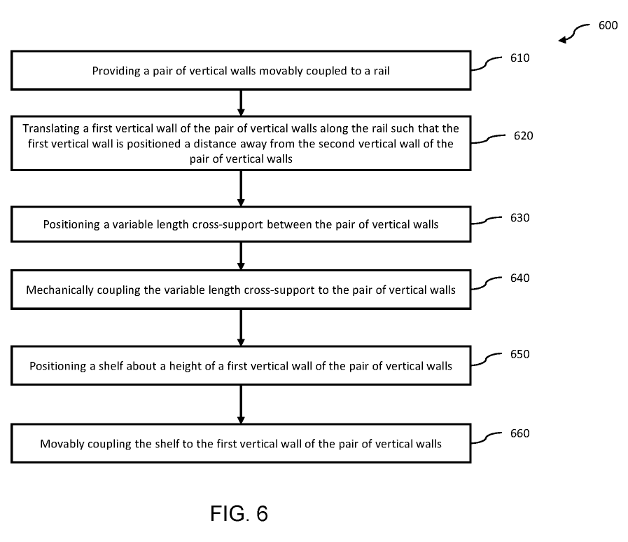

Reference is now made to FIG. 6, which depicts a block flow diagram illustrating a method 600 in which a modular battery rack system 100 may be installed. The method 600 includes block 610 by providing a pair of vertical walls 10 movably coupled to a rail 21. The method 600 further includes block 620 by translating a first vertical wall 10 of the pair of vertical walls 10 along the rail 21 such that the first vertical wall 10 is positioned a distance away from the second vertical wall 10 of the pair of vertical walls 10. The method 600 further includes block 630 by positioning a variable length cross-support 18 between the pair of vertical walls 10. The method 600 further includes block 640 by mechanically coupling the variable length cross-support 18 to the pair of vertical walls 10. The method 600 further includes block 650 by positioning a shelf 12 about a height of a first vertical wall 10 of the pair of vertical walls 10. The method 600 further includes block 660 by movably coupling the shelf 12 to the first vertical wall 10 of the pair of vertical walls 10.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

What is claimed is:

1. A battery rack comprising:
a rail member having a rail and a pair of carriages movably coupled to the rail;
a pair of vertical walls, each having a bracket, a column, and a movable fastener movably coupled to the column and mechanically coupled to the bracket;
wherein the movable fastener can be configured to be in a movable state where the movable fastener is slidably movable along a height of the column and a fixed state where the movable fastener is not slidably movable along the height of the column;
wherein each of the pair of vertical walls are respectively mechanically coupled to the pair of carriages; and
at least one cross-support having a variable length and is mechanically coupled to the pair of vertical walls.

2. The battery rack of claim 1, wherein the at least one cross-support includes a pair of opposed coupling ends, the pair of opposed coupling ends are movably coupled to each other, the pair of opposed coupling ends configured to be mechanically coupled to the pair of vertical walls.

3. The battery rack of claim 2, further comprising an extension member positioned between the pair of opposed coupling ends, the pair of opposed coupling ends are movably coupled to the extension member.

4. The battery rack of claim 3, further comprising a cross-support movable fastener positioned within the extension member and movably coupled to at least one of the pair of opposed coupling ends.

5. The battery rack of claim 1, wherein the movable fastener includes a female threaded portion.

6. The battery rack of claim 1, wherein the bracket is generally L-shaped.

7. The battery rack of claim 1, further comprising a second rail member having a second rail and a second pair of carriages movably coupled to the second rail, wherein the pair of vertical walls are respectively coupled to the second pair of carriages.

8. The battery rack of claim 1, wherein the rail is configured to allow linear movement of the pair of vertical walls along the rail.

9. A method of assembling a battery rack, the method comprising:
providing a pair of vertical walls movably coupled to a rail;
translating a first vertical wall of the pair of vertical walls along the rail such that the first vertical wall is positioned a distance away from a second vertical wall of the pair of vertical walls;
positioning a variable length cross-support between the pair of vertical walls;
mechanically coupling the variable length cross-support to the pair of vertical walls;
positioning a shelf about a height of the first vertical wall of the pair of vertical walls; and
movably coupling the shelf to the first vertical wall of the pair of vertical walls.

10. The method according to claim 9, further comprising extending an end of the variable length cross-support away from an opposed end of the variable length cross-support such that the end contacts the first vertical wall and the opposed end contacts the second vertical wall.

11. The method according to claim 9, further comprising positioning a second shelf about the height of the second vertical wall of the pair of vertical walls and movably coupling the second shelf to the second vertical wall of the pair of vertical walls.

12. The method according to claim 11, further comprising positioning a battery on the first and second shelves such that a bottom surface of the battery contacts the first and second shelves.

13. The method according to claim 9, further comprising actuating a locking mechanism to secure the shelf to the first vertical wall of the pair of vertical walls.

14. A modular battery rack system, the system comprising:
a pair of vertical walls, each vertical wall having a carriage coupled to a bottom end of the vertical wall, a vertical adjustment column, and a shelf that is movably mechanically coupled to the vertical adjustment column;
wherein the shelf has a movable state where the shelf can be moved along a height of the vertical adjustment column and a fixed state where the shelf is fixed about a point along the height of the vertical adjustment column;
a rail is movably mechanically coupled to each respective carriage; and
at least one cross-support having a variable length, the at least one cross-support being mechanically coupled to the pair of vertical walls.

15. The modular battery rack system of claim 14, wherein the at least one cross-support includes a pair of opposed coupling ends, the pair of opposed coupling ends are movably coupled to each other, the pair of opposed coupling ends configured to be mechanically coupled to the pair of vertical walls.

16. The modular battery rack system of claim 15, further comprising an extension member positioned between the pair of opposed coupling ends, the pair of opposed coupling ends are movably coupled to the extension member.

17. The modular battery rack system of claim 14, wherein the rail is configured to allow linear movement of the pair of vertical walls along the rail.

18. The modular battery rack system of claim 14, further comprising a locking mechanism associated with the shelf, the locking mechanism configured to transition the shelf to the fixed state when actuated.

19. The modular battery rack system of claim 14, wherein the shelf is generally L-shaped.

20. The modular battery rack system of claim 14, further comprising a second rail and a second carriage coupled to the bottom end of each of the pair of vertical walls and movably coupled to the second rail.
